(19) United States
(12) Patent Application Publication
(10) Pub. No.: US 2025/0223144 A1
(43) Pub. Date: Jul. 10, 2025

(54) CARGO HANDLING CONTROL DEVICE OF FORKLIFT TRUCK

(71) Applicant: KABUSHIKI KAISHA TOYOTA JIDOSHOKKI, Kariya-shi (JP)

(72) Inventor: Yoshiki KAKITA, Kariya-shi (JP)

(73) Assignee: KABUSHIKI KAISHA TOYOTA JIDOSHOKKI, Kariya-shi (JP)

(21) Appl. No.: 19/011,857

(22) Filed: Jan. 7, 2025

(30) Foreign Application Priority Data
Jan. 9, 2024 (JP) 2024-001285

(51) Int. Cl. B66F 9/075

(52) U.S. Cl. CPC B66F 9/0755

(57) ABSTRACT

A cargo handling control device of a forklift truck including a lift cylinder, and a tilt cylinder. The cargo handling control device includes an approach distance detector, an insertion controller, an insertion amount calculator, a pre-insertion determination unit, a first fork operation controller, and a second fork operation controller. The first fork operation controller causes the fork to move up and down toward a center of the pallet in a height direction of the pallet in a case where the tip portion of the fork is determined to be in the pre-insertion state. The second fork operation controller causes the fork to tilt to be positioned along an inner wall surface of an upper wall or a lower wall of the pallet and the fork to move up and down in the case where the tip portion of the fork is determined to be in a post-insertion state.

### CROSS-REFERENCE TO RELATED APPLICATION

This application claims priority to Japanese Patent Application No. 2024-001285 filed on Jan. 9, 2024, the entire disclosure of which is incorporated herein by reference.

The present disclosure relates to a cargo handling control device of a forklift truck.

### BACKGROUND ART

As a conventional cargo handling control device of a forklift truck, a technique disclosed in Japanese Patent Application Publication No. 2023-57735 has been known. The cargo handling control device disclosed in the Publication includes a sensor and a control device. The sensor detects whether a distance between an insertion portion of a fork and a facing surface of a pallet in which an insertion hole is formed is equal to or less than a predetermined value. When this sensor detects that the insertion portion approaches the facing surface such that the distance between the insertion portion and the facing surface becomes equal to or less than the predetermined value, the control device executes avoidance processing in which the insertion portion is separated from the facing surface of the insertion hole so that a height of the insertion portion relative to an entrance of the insertion hole does not change by controlling a tilting device and a vertical movement device after executing processing to stop a moving device.

In the above conventional technique, in performing picking up of the pallet, a change in height of the fork by tilting control of the fork is offset by vertical movement control of the fork so that the height of the fork at the entrance of the pallet insertion hole (pallet hole) does not change. However, in inserting the fork into the pallet hole of the pallet by detecting the pallet in the forklift truck that is automatedly operable, the fork may not be positioned at a center of the pallet in a height direction thereof due to variations in pallet detection and variations in fork control, and is positioned in proximity to an upper wall or a lower wall of the pallet. In this case, tilting control and vertical movement control of the fork along the inner wall of the upper wall or the lower wall of the pallet are performed, despite the fact that the pallet is not tilted, which may lead to a picking up failure.

The present disclosure is directed to providing a cargo handling control device of a forklift truck that can adequately insert a fork into a pallet hole of a pallet, regardless of tilting of the pallet.

### SUMMARY

In accordance with an aspect of the present disclosure, there is provided a cargo handling control device of a forklift truck including a lift cylinder that moves a fork holding a pallet up and down, and a tilt cylinder that tilts the fork, the cargo handling control device includes an approach distance detector configured to detect an approach distance from a tip portion of the fork to a front surface of the pallet, an insertion controller configured to control the forklift truck so that the fork is inserted into a pallet hole of the pallet, an insertion amount calculator configured to calculate an insertion amount of the fork relative to the pallet hole, after the insertion controller starts processing, based on the approach distance detected by the approach distance detector, and a moving distance of the fork, a pre-insertion determination unit configured to determine whether the tip portion of the fork is in a pre-insertion state in which the tip portion of the fork has yet to be inserted into the pallet hole, after the insertion controller starts processing, based on the insertion amount of the fork relative to the pallet hole calculated by the insertion amount calculator, a first fork operation controller configured to control the lift cylinder so that the fork moves up and down toward a center of the pallet in a height direction of the pallet, after the insertion controller starts processing, in a case where the pre-insertion determination unit determines that the tip portion of the fork is in the pre-insertion state, and a second fork operation controller configured to control the tilt cylinder so that the fork tilts to be positioned along an inner wall surface of an upper wall of the pallet or an inner wall surface of a lower wall of the pallet and to control the lift cylinder so that the fork moves up and down toward the center of the pallet in the height direction, in the case where the pre-insertion determination unit determines that the tip portion of the fork is in a post-insertion state in which the tip portion of the fork has been inserted into the pallet hole of the pallet after the insertion controller starts processing.

Other aspects and advantages of the disclosure will become apparent from the following description, taken in conjunction with the accompanying drawings, illustrating by way of example the principles of the disclosure.

### BRIEF DESCRIPTION OF DRAWINGS

The disclosure, together with objects and advantages thereof, may best be understood by reference to the following description of the presently preferred embodiments together with the accompanying drawings in which:

FIG. 1 is a block diagram illustrating a configuration of a cargo handling control device of a forklift truck according to an embodiment of the present disclosure;

FIGS. 2A and 2B are side views illustrating a front part of the forklift truck with a pallet (cross-sectional view);

FIG. 3 is a cross-sectional view illustrating an upper hole sensor in FIG. 1 and a position of the upper hole sensor;

FIG. 4 is a flowchart showing steps of fork insertion control processing executed by a controller illustrated in FIG. 1;

FIG. 5 is a flowchart showing the details of steps of upper approach fork operation control processing in FIG. 4;

FIG. 6 is a flowchart showing the details of steps of lower approach fork operation control processing in FIG. 4;

FIGS. 7A-7C are cross-sectional views illustrating an example of a fork being inserted into a pallet hole of a pallet placed on a flat surface that is not inclined;

FIGS. 8A-8C are cross-sectional views illustrating another example of a fork being inserted into a pallet hole of a pallet placed on a flat surface that is not inclined;

FIGS. 9A-9C are cross-sectional views illustrating an example of a fork being inserted into a pallet hole of a pallet placed on an inclined surface in which a front side is higher than a rear side;

FIGS. 10A-10C are cross-sectional views illustrating an example of a fork being inserted into a pallet hole of a pallet placed on an inclined surface in which a front side is higher than a rear side;

FIGS. 11A-11C are cross-sectional views illustrating an example of a fork being inserted into a pallet hole of a pallet placed on an inclined surface in which a front side is lower than a rear side;

FIGS. 12A-12C are cross-sectional views illustrating an example of a fork being inserted into a pallet hole of a pallet placed on an inclined surface in which a front side is lower than a rear side;

FIG. 13 is a block diagram illustrating a configuration of a cargo handling control device of a forklift truck according to another embodiment of the present disclosure;

FIG. 14 is a cross-sectional view illustrating a pallet having a structure different from the pallet in FIGS. 2A and 2B;

FIG. 15 is a flowchart showing a modified example of the steps of upper approach fork operation control processing in FIG. 5; and

FIG. 16 is a flowchart showing a modified example of the steps of lower approach fork operation control processing in FIG. 6.

### DETAILED DESCRIPTION OF THE EMBODIMENTS

The following will describe an embodiment of the present disclosure in detail with reference to the accompanying drawings. It is to be noted that, in the drawings, identical or equivalent elements are denoted by the same reference numerals, and description thereof will be omitted.

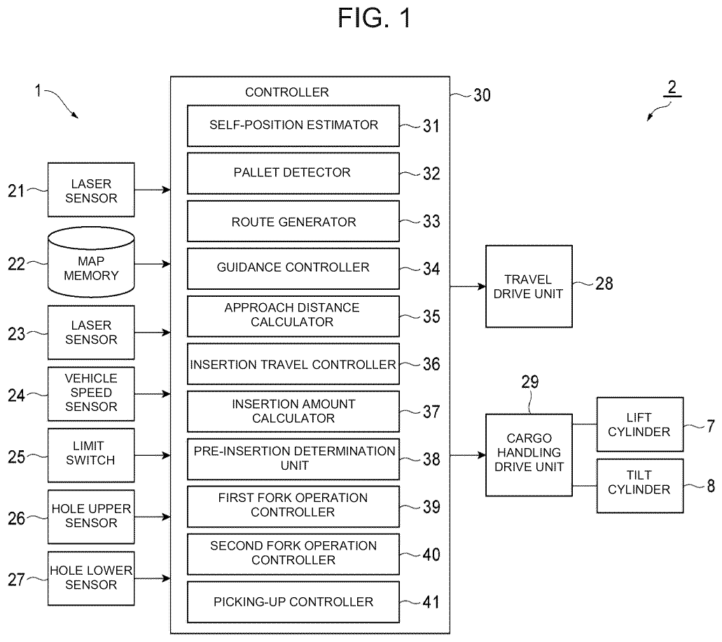

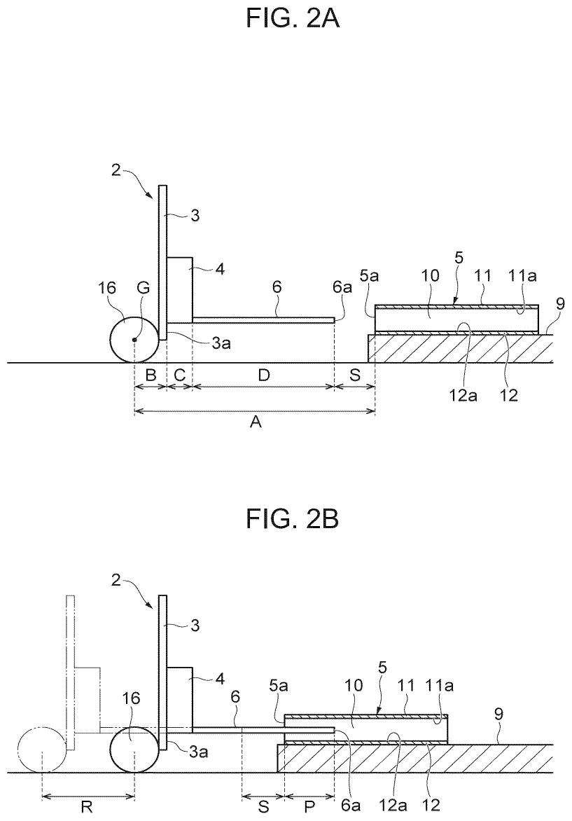

FIG. 1 is a block diagram illustrating a configuration of a cargo handling control device of a forklift truck according to an embodiment of the present disclosure. In FIG. 1, a cargo handling control device 1 of the present embodiment is mounted on a forklift truck 2. As illustrated in FIGS. 2A-2B, the forklift truck 2 includes a mast 3, and a pair of forks 6 on the left and right that is mounted to the mast 3 via a spacer 4 and movable up and down. The forks 6 holds a pallet 5.

In addition, the forklift truck 2 includes a lift cylinder 7 configured to move the forks 6 up and down, and a tilt cylinder 8 configured to tilt the forks 6 by tilting the mast 3 (see FIG. 1). In addition, the forklift truck 2 includes a side shift cylinder (not illustrated) configured to move the forks 6 in the right-left direction (lateral direction) of the forklift truck 2.

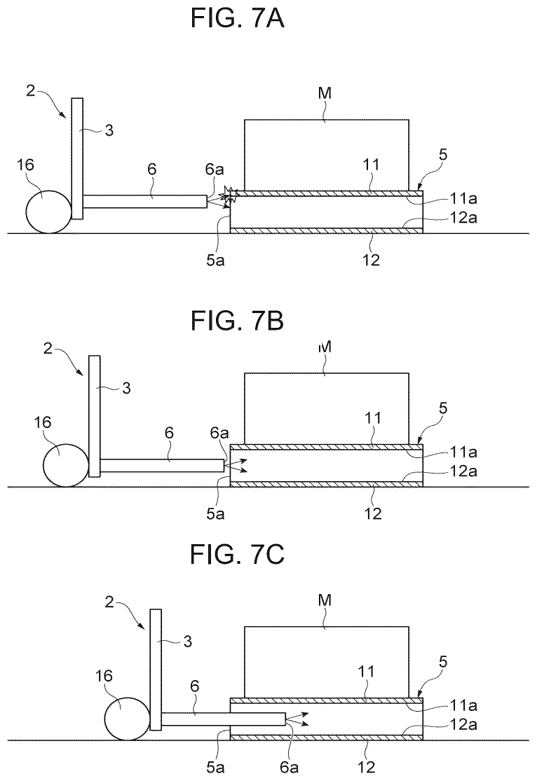

The pallet 5 is a bed on which a cargo M (see FIGS. 7A-7C, 8A-8C, 9A-9C, 10A-10C, 11A-11C and to 12A-12C) is placed. The pallet 5 is a flat pallet, for example. The pallet 5 has a substantially quadrangular shape in the plan view. The pallet 5 is placed on a loading platform 9 of a truck or the like, or on the ground. The pallet 5 has two pallet holes 10 into which the forks 6 are inserted. The pallet 5 has an upper wall 11 and a lower wall 12 that form the pallet holes 10. The upper wall 11 and the lower wall 12 have an inner wall surface 11a and an inner wall surface 12a, respectively, that face each other.

The cargo handling control device 1 is a device that automatedly picks up the pallet 5 by the forklift truck 2. The cargo handling control device 1 causes the forks 6 to be inserted into the pallet holes 10 of the pallet 5 and lifts the pallet 5 with the forks 6 in that state. Although the cargo handling control device 1 includes two forks 6 and the pallet 5 has two pallet holes 10, for the sake of description, one fork 6 and its associated one pallet hole 10 will be described in the following description.

The cargo handling control device 1 includes a laser sensor 21, a map memory 22, a laser sensor 23, a vehicle speed sensor 24, a limit switch 25, a hole upper sensor 26, a hole lower sensor 27, a travel drive unit 28, a cargo handling drive unit 29, and a controller 30.

The laser sensor 21 irradiates the vicinity of the forklift truck 2 with a laser beam and receives laser reflection to detect a distance to an object present in the vicinity of the forklift truck 2 and acquire point cloud data. The point cloud is a collection of reflection points. The laser sensor 21 has a 360-degree laser irradiation range in the horizontal direction. The laser sensor 21 may be a 3D LIDAR or the like, for example.

The map memory 22 stores map data of an area in which the forklift truck 2 travels. The map data includes buildings, pillars, shelves, walls, and the like. The map data is created in advance using the laser sensor 21.

The laser sensor 23 irradiates an area in front of the forklift truck 2 with a laser beam and receives laser reflection to detect a distance to an object present in front of the forklift truck 2 and obtain point cloud data. The object located in front of the forklift truck 2 includes the pallet 5. A laser irradiation range of the laser sensor 23 in the horizontal direction is narrower than the laser irradiation range of the laser sensor 21 in the horizontal direction.

The vehicle speed sensor 24 detects a travel speed of the forklift truck 2. Although it is not illustrated, the limit switch 25 is attached to the spacer 4. The limit switch 25 detects contact with the pallet 5 after a start of insertion of the fork 6 into the pallet hole 10 of pallet 5. The limit switch 25 outputs an ON signal as a detection signal when the limit switch 25 comes into contact with a front surface 5a of the pallet 5.

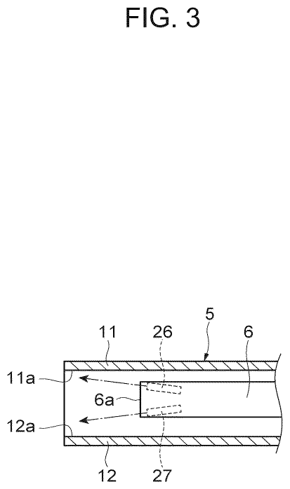

The hole upper sensor 26 and the hole lower sensor 27 are arranged vertically inside a tip portion 6a of the fork 6, as illustrated in FIG. 3. As the hole upper sensor 26 and the hole lower sensor 27, a reflective photoelectric sensor that emits one dimension light is used, for example.

The hole upper sensor 26 is a sensor that detects whether the tip portion 6a of the fork 6 is positioned in proximity to the upper wall 11 of the pallet 5. The hole upper sensor 26 serves as a pallet upper wall detector that detects whether a distance from the tip portion 6a of the fork 6 to the upper wall 11 of the pallet 5 is equal to or less than a predetermined value. The hole upper sensor 26 outputs an ON signal as a detection signal when the distance from the tip portion 6a of the fork 6 to the upper wall 11 of the pallet 5 is equal to or less than the predetermined value. The predetermined value is, for example, about several mm.

The hole lower sensor 27 is a sensor that detects whether the tip portion 6a of the fork 6 is positioned in proximity to the lower wall 12 of the pallet 5. The hole lower sensor 27 serves as a pallet lower wall detector that detects whether a distance from the tip portion 6a of the fork 6 to the lower wall 12 of the pallet 5 is equal to or less than a predetermined value. The hole lower sensor 27 outputs an ON signal as a detection signal when the distance from the tip portion 6a of the fork 6 to the lower wall 12 of the pallet 5 is equal to or less than the predetermined value. The predetermined value for the hole lower sensor 27 is the same as that for the hole upper sensor 26.

The travel drive unit 28 is configured to drive the forklift truck 2 to travel. The travel drive unit 28 includes a traveling motor (not illustrated) for rotating a front wheel 16 (see FIGS. 2A-2B) as drive wheels and a steering motor (not illustrated) for steering a rear wheel as the steered wheels, for example.

The cargo handling drive unit 29 is configured to operate a hydraulic actuators for cargo handling, such as the lift cylinder 7 and the tilt cylinder 8. The cargo handling drive unit 29 is, for example, an oil control valve (not illustrated) disposed between a hydraulic pump and the lift cylinder 7 and the tilt cylinder 8.

The controller 30 includes a central processing unit (CPU), a random access memory (RAM), a read-only memory (ROM), input/output interfaces, and the like. The controller 30 has a self-position estimator 31, a pallet detector 32, a route generator 33, a guidance controller 34, an approach distance calculator 35, an insertion travel controller 36, an insertion amount calculator 37, a pre-insertion determination unit 38, a first fork operation controller 39, a second fork operation controller 40, and a picking-up controller 41.

The self-position estimator 31 estimates a self-position of the forklift truck 2 based on the point cloud data obtained by the laser sensor 21 and the map data stored in the map memory 22. Specifically, the self-position estimator 31 estimates the self-position of the forklift truck 2 by matching the point cloud data by the laser sensor 21 with the map data, for example, using SLAM (simultaneous localization and mapping) method. The SLAM is a self-position estimation technique that uses sensor data and map data to estimate a self-position.

The pallet detector 32 detects the position and posture of the pallet 5 relative to the forklift truck 2 based on the point cloud data by the laser sensor 23, and calculates an insertion start position where the fork 6 can be inserted into the pallet hole 10 of the pallet 5. The insertion start position is a position in front of the pallet 5, where the tip portion 6a of the fork 6 faces the pallet hole 10 of pallet 5.

The route generator 33 generates a travel route from a current position of the forklift truck 2 estimated by the self-position estimator 31 to the insertion start position calculated by the pallet detector 32.

The guidance controller 34 controls the travel drive unit 28 so that the forklift truck 2 is guided to the insertion start position along the travel route generated by the route generator 33 based on the self-position of the forklift truck 2 estimated by the self-position estimator 31.

After the forklift truck 2 has reached the insertion start position, the approach distance calculator 35 calculates an approach distance S, which is a distance from the tip portion 6a of the fork 6 to the front surface 5a of the pallet 5, based on the point cloud data from the laser sensor 23 and the vehicle specifications of the forklift truck 2. The approach distance calculator 35 and the laser sensor 23 cooperate to form an approach distance detector that detects an approach distance S.

At this time, as illustrated in FIG. 2A, the laser sensor 23 detects a distance A from the forklift truck 2 to the front surface 5a of the pallet 5 with a center axis G of the front wheel 16 as the point of origin. Thus, the approach distance calculator 35 calculates the approach distance S by subtracting a distance B between the center axis G of the front wheel 16 and a front surface 3a of the mast 3, a length C of the spacer 4, and a length D of the fork 6 from the distance A from the forklift truck 2 to the front surface 5a of the pallet 5.

After the approach distance S is calculated by the approach distance calculator 35, the insertion travel controller 36 controls the travel drive unit 28 so that the fork 6 is inserted into the pallet hole 10 of the pallet 5. The insertion travel controller 36 forms an insertion controller that controls the forklift truck 2 so that the fork 6 is inserted into the pallet hole 10 of the pallet 5.

The insertion amount calculator 37 calculates an insertion amount P of the fork 6 relative to the pallet hole 10 of the pallet 5 based on the approach distance S calculated by the approach distance calculator 35 and a moving distance of the fork 6, after the insertion travel controller 36 starts processing. As illustrated in FIG. 2B, the insertion amount calculator 37 obtains a travel distance R of the forklift truck 2 as the moving distance of the fork 6, and calculates the insertion amount P of the fork 6 relative to the pallet hole 10 based on the approach distance S and the travel distance R of the forklift truck 2.

After the insertion travel controller 36 starts processing, the pre-insertion determination unit 38 determines whether the tip portion 6a of the fork 6 is in a pre-insertion state in which the tip portion 6a of the fork 6 has yet to be inserted into the pallet hole 10 of the pallet 5, based on the insertion amount P of the fork 6 relative to the pallet hole 10 of the pallet 5 calculated by the insertion amount calculator 37.

The first fork operation controller 39 controls the lift cylinder 7 via the cargo handling drive unit 29 so that the fork 6 moves up and down toward the center of the pallet 5 in a height direction thereof when the pre-insertion determination unit 38 determines that the tip portion 6a of the fork 6 is in the pre-insertion state in which the tip portion 6a of the fork 6 has yet to be inserted into the pallet hole 10 of the pallet 5 after the insertion travel controller 36 starts processing.

Specifically, in a case where the pre-insertion determination unit 38 determines that the tip portion 6a of the fork 6 is in the pre-insertion state in which the tip portion 6a of the fork 6 has yet to be inserted into the pallet hole 10, when the hole upper sensor 26 determines that the distance from the tip portion 6a of the fork 6 to the upper wall 11 of the pallet 5 is equal to or less than the predetermined value, the first fork operation controller 39 controls the lift cylinder 7 via the cargo handling drive unit 29 so that the fork 6 moves down. In the case where the pre-insertion determination unit 38 determines that the tip portion 6a of the fork 6 is in the pre-insertion state in which the tip portion 6a of the fork 6 has yet to be inserted into the pallet hole 10, when the hole lower sensor 27 determines that the distance from the tip portion 6a of the fork 6 to the lower wall 12 of the pallet 5 is equal to or less than the predetermined value, the first fork operation controller 39 controls the lift cylinder 7 via the cargo handling drive unit 29 so that the fork 6 moves up.

More specifically, in the case where the pre-insertion determination unit 38 determines that the tip portion 6a of the fork 6 is in the pre-insertion state in which the tip portion 6a of the fork 6 has yet to be inserted into the pallet hole 10, when the hole upper sensor 26 detects that the distance from the tip portion 6a of the fork 6 to the upper wall 11 of the pallet 5 is equal to or less than the predetermined value, the first fork operation controller 39 controls the lift cylinder 7 via the cargo handling drive unit 29 so that the fork 6 moves down incrementally by a certain amount until the hole upper sensor 26 detects that the distance from the tip portion 6a of the fork 6 to the upper wall 11 of the pallet 5 is not equal to or less than the predetermined value. In the case where the pre-insertion determination unit 38 determines that the tip portion 6a of the fork 6 is in the pre-insertion state in which the tip portion 6a of the fork 6 has yet to be inserted into the pallet hole 10, when the hole lower sensor 27 detects that the distance from the tip portion 6a of the fork 6 to the lower wall 12 of the pallet 5 is equal to or less than the predetermined value, the first fork operation controller 39 controls the lift cylinder 7 via the cargo handling drive unit 29 so that the fork 6 moves up incrementally by a certain amount until the hole lower sensor 27 detects that the distance from the tip portion 6a of the fork 6 to the lower wall 12 of the pallet 5 is not equal to or less than the predetermined value.

In a case where the pre-insertion determination unit 38 determines that the tip portion 6a of the fork 6 is in a post-insertion state in which the tip portion 6a of the fork 6 has been inserted into the pallet hole 10, the second fork operation controller 40 controls the tilt cylinder 8 via the cargo handling drive unit 29 so that the fork 6 tilts to be positioned along the inner wall surface 11a of the upper wall 11 or the inner wall surface 12a of the lower wall 12, and controls the lift cylinder 7 via the cargo handling drive unit 29 so that the fork 6 moves up and down toward the center of the pallet 5 in the height direction.

Specifically, in the case where the pre-insertion determination unit 38 determines that the tip portion 6a of the fork 6 is in the post-insertion state in which the tip portion 6a of the fork 6 has been inserted into the pallet hole 10, when the hole upper sensor 26 detects that the distance from the tip portion 6a of the fork 6 to the upper wall 11 of the pallet 5 is equal to or less than the predetermined value, the second fork operation controller 40 controls the tilt cylinder 8 via the cargo handling drive unit 29 so that the fork 6 tilts forward and controls the lift cylinder 7 via the cargo handling drive unit 29 so that the fork 6 moves up. In the case where the pre-insertion determination unit 38 determines that the tip portion 6a of the fork 6 is in the post-insertion state in which the tip portion 6a of the fork 6 has been inserted into the pallet hole 10, when the hole lower sensor 27 detects that the distance from the tip portion 6a of the fork 6 to the lower wall 12 of the pallet 5 is equal to or less than the predetermined value, the second fork operation controller 40 controls the tilt cylinder 8 via the cargo handling drive unit 29 so that the fork 6 tilts backward and controls the lift cylinder 7 via the cargo handling drive unit 29 so that the fork 6 moves down.

More specifically, in the case where the pre-insertion determination unit 38 determines that the tip portion 6a of the fork 6 is in the post-insertion state in which the tip portion 6a of the fork 6 has been inserted into the pallet hole 10, when the hole upper sensor 26 detects that the distance from the tip portion 6a of the fork 6 to the upper wall 11 of the pallet 5 is equal to or less than the predetermined value, the second fork operation controller 40 controls the tilt cylinder 8 via the cargo handling drive unit 29 so that the fork 6 tilts forward incrementally by a certain amount and controls the lift cylinder 7 via the cargo handling drive unit 29 so that the fork 6 moves up incrementally by a certain amount until the hole upper sensor 26 determines that the distance from the tip portion 6a of the fork 6 to the upper wall 11 of the pallet 5 is not equal to or less than the predetermined value. In the case where the pre-insertion determination unit 38 determines that the tip portion 6a of the fork 6 is in the post-insertion state in which the tip portion 6a of the fork 6 has been inserted into the pallet hole 10, when the hole lower sensor 27 detects that the distance from the tip portion 6a of the fork 6 to the lower wall 12 of the pallet 5 is equal to or less than the predetermined value, the second fork operation controller 40 controls the tilt cylinder 8 via the cargo handling drive unit 29 so that the fork 6 tilts backward incrementally by a certain amount and controls the lift cylinder 7 via the cargo handling drive unit 29 so that the fork 6 moves down incrementally by a certain amount until the hole lower sensor 27 determines that the distance from the tip portion 6a of the fork 6 to the lower wall 12 of the pallet 5 is not equal to or less than the predetermined value

After the insertion of the fork 6 into the pallet hole 10 of the pallet 5 is completed by the second fork operation controller 40, the picking-up controller 41 controls the lift cylinder 7 via the cargo handling drive unit 29 so that the fork 6 moves up to lift the pallet 5.

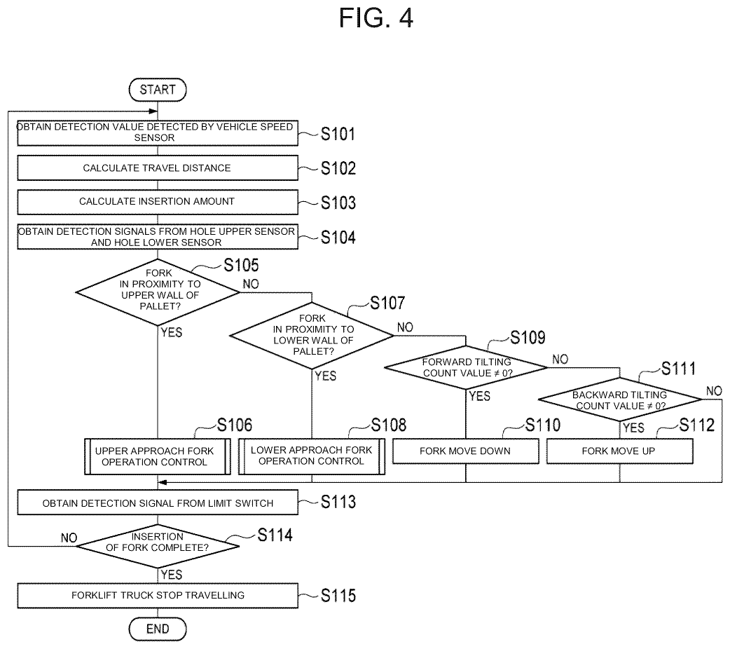

FIG. 4 is a flowchart showing steps of fork insertion control processing executed by the controller 30. This processing is executed by the insertion travel controller 36, the insertion amount calculator 37, the pre-insertion determination unit 38, the first fork operation controller 39, and the second fork operation controller 40 after the insertion travel controller 36 starts processing.

At a start of this processing, both a forward tilting count value and a backward tilting count value are set to 0. The forward tilting count value indicates a forward tilting amount of the fork 6. When the forward tilting count value is 0, the fork 6 is not tilted forward. As the forward tilting count value increases, the forward tilting amount of the fork 6 increases. The backward tilting count value indicates a backward tilting amount of the fork 6. When the backward tilting count value is 0, the fork 6 is not tilted backward. As the backward tilting count value increases, the backward tilting amount of the fork 6 increases.

As shown in FIG. 4, the controller 30, firstly, obtains a detection value detected by the vehicle speed sensor 24 (step S101). Then, the controller 30 calculates the travel distance R of the forklift truck 2 from the insertion start position (mentioned above) based on the detection value by the vehicle speed sensor 24 (step S102). At this time, the controller 30 calculates the travel distance R of the forklift truck 2 by multiplying the travel speed of the forklift truck 2 by a travel time.

Next, the controller 30 calculates the insertion amount P of the fork 6 into the pallet hole 10 of the pallet 5 based on the approach distance S calculated by the approach distance calculator 35 and the travel distance R of the forklift truck 2 (step S103). At this time, as illustrated in FIG. 2B, the controller 30 calculates the insertion amount P of the fork 6 according to the following equation.

Insertion amount P=Travel distance R−Approach distance S

Next, the controller 30 obtains detection signals from the hole upper sensor 26 and the hole lower sensor 27 (Step S104). Then, the controller 30 determines whether the tip portion 6a of the fork 6 is positioned in proximity to the upper wall 11 of the pallet 5 based on the detection signal from the hole upper sensor 26 (step S105). When the tip portion 6a of the fork 6 is positioned in proximity to the upper wall 11 of the pallet 5, the tip portion 6a of the fork 6 is highly likely to hit the upper wall 11 of the pallet 5 if the forklift truck 2 continues to travel in that state.

When the controller 30 determines that the tip portion 6a of the fork 6 is positioned in proximity to the upper wall 11 of the pallet 5, the controller 30 executes upper approach fork operation control processing (step S106).

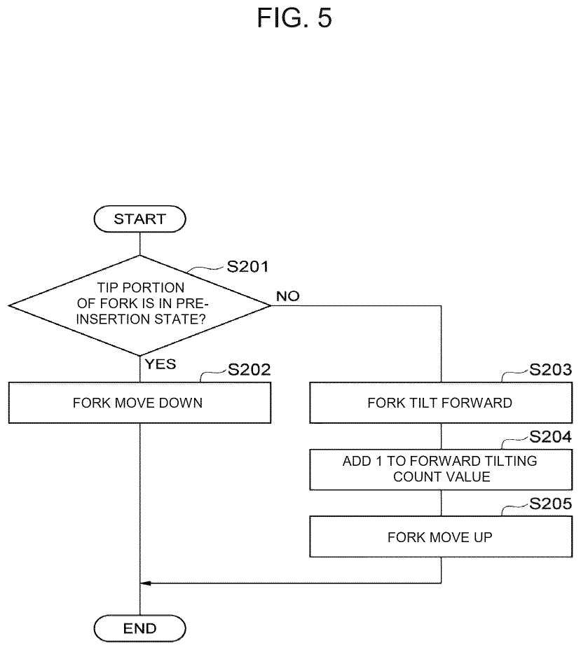

FIG. 5 is a flowchart showing the details of steps of the upper approach fork operation control processing. In FIG. 5, the controller 30 firstly determines whether or not the tip portion 6a of the fork 6 is in the pre-insertion state in which the tip portion 6a of the fork 6 has yet to be inserted into the pallet hole 10 of the pallet 5 based on the insertion amount P of the fork 6 relative to the pallet hole 10 of the pallet 5 calculated in step S103 (step S201).

At this time, when the insertion amount P of the fork 6 is negative (−), it is determined that the tip portion 6a of the fork 6 is in the pre-insertion state in which the tip portion 6a of the fork 6 has yet to be inserted into the pallet hole 10 of the pallet 5. When the insertion amount P of the fork 6 is positive (+), it is determined that the tip portion 6a of the fork 6 is in the post-insertion state in which the tip portion 6a of the fork 6 has been inserted into the pallet hole 10 of the pallet 5.

In the case where it is determined that the tip portion 6a of the fork 6 is in the pre-insertion state in which the tip portion 6a of the fork 6 has yet to be inserted into the pallet hole 10, the controller 30 controls the cargo handling drive unit 29 so that the fork 6 moves down by a predetermined distance (step S202). A moving down distance is set, for example, to a few millimeters, which is determined depending on the dimension in height of the pallet 5.

In the case where it is determined that the tip portion 6a of the fork 6 is not in the pre-insertion state in which the tip portion 6a of the fork 6 has yet to be inserted into the pallet hole 10, the controller 30 controls the cargo handling drive unit 29 so that the fork 6 tilts forward by a predetermined angle (step S203). A forward tilt angle is set, for example, to a few degrees, which is set based on the dimensions in length, width and height of the pallet 5. Then, the controller 30 adds 1 to the forward tilting count value (step S204).

In addition, the controller 30 controls the cargo handling drive unit 29 so that the fork 6 moves up by a predetermined distance (step S205). The moving up distance is equal to the moving down distance in step S202, for example.

Returning to FIG. 4, when it is determined that the tip portion 6a of the fork 6 is not positioned in proximity to the upper wall 11 of the pallet 5 in step S105, the controller 30 determines whether the tip portion 6a of the fork 6 is positioned in proximity to the lower wall 12 of the pallet 5 (step S107), based on the detection signal from the hole lower sensor 27. When the tip portion 6a of the fork 6 is positioned in proximity to the lower wall 12 of the pallet 5, the tip portion 6a of the fork 6 is highly likely to hit the lower wall 12 of the pallet 5 if the forklift truck 2 continues to travel in that state.

When the controller 30 determines that the tip portion 6a of the fork 6 is positioned in proximity to the lower wall 12 of the pallet 5, the controller 30 executes lower approach fork operation control processing (step S108).

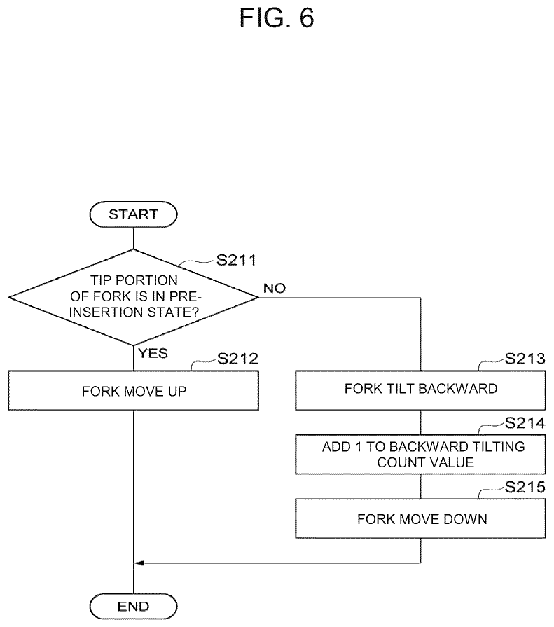

FIG. 6 is a flowchart showing the details of steps of the lower approach fork operation control processing. In FIG. 6, the controller 30 determines whether or not the tip portion 6a of the fork 6 is in the pre-insertion state in which the tip portion 6a of the fork 6 has yet to be inserted into the pallet hole 10 of the pallet 5 based on the insertion amount P of the fork 6 relative to the pallet hole 10 of the pallet 5 calculated in step S103 (step S211).

In the case where it is determined that the tip portion 6a of the fork 6 is in the pre-insertion state in which the tip portion 6a of the fork 6 has yet to be inserted into the pallet hole 10, the controller 30 controls the cargo handling drive unit 29 so that the fork 6 moves up by the predetermined distance (step S212). The moving up distance is equal to the moving down distance in step S202, for example.

In the case where it is determined that the tip portion 6a of the fork 6 is not in the pre-insertion state in which the tip portion 6a of the fork 6 has yet to be inserted into the pallet hole 10 of the pallet 5, the controller 30 controls the cargo handling drive unit 29 so that the fork 6 tilts backward by the predetermined angle (step S213). The backward tilting angle is equal to the forward tilting angle in step S203, for example. Then, the controller 30 adds 1 to the backward tilting count value (step S214).

In addition, the controller 30 controls the cargo handling drive unit 29 so that the fork 6 moves down by the predetermined distance (step S215). The moving down distance is equal to the moving down distance in step S202, for example.

Returning to FIG. 4, when it is determined in step S107 that the tip portion 6a of the fork 6 is not positioned in proximity to the lower wall 12 of the pallet 5, the controller 30 determines whether the forward tilting count value is not 0 (step S109).

When the controller 30 determines that the forward tilting count value is not 0, the controller 30 controls the cargo handling drive unit 29 so that the fork 6 moves down by a distance corresponding to the forward tilting count value (Step S110). At this time, as the forward tilting count value increases, the moving down distance of the fork 6 becomes greater.

When the controller 30 determines that the forward tilting count value is 0, the controller 30 checks whether the backward tilting count value is not 0 (step S111). When the controller 30 determines that the backward tilting count value is not 0, the controller 30 controls the cargo handling drive unit 29 so that the fork 6 moves up by a distance corresponding to the backward tilting count value (Step S112). As the backward tilting count value increases, the moving up distance of the fork 6 becomes greater.

After executing any of steps S106, S108, S110, and S112, or when the controller 30 determines in step S111 that the backward tilting count value is 0, the controller 30 obtains a detection signal from the limit switch 25 (step S113). Then, the controller 30 determines whether the insertion of the fork 6 into the pallet hole 10 of the pallet 5 is complete based on the detection signal from the limit switch 25 (step S114).

When the controller 30 determines that the insertion of the fork 6 into the pallet hole 10 of the pallet 5 is not complete, the controller 30 executes the above step S101 again. When the controller 30 determines that the insertion of the fork 6 into the pallet hole 10 of the pallet 5 is complete, the controller 30 controls the travel drive unit 28 so that the forklift truck 2 stops travelling (step S115), and ends the processing.

Here, the insertion travel controller 36 executes the above steps S113 to S115. The insertion amount calculator 37 executes the above steps S101 to S103. The pre-insertion determination unit 38 executes the above steps S201 and S211. The first fork operation controller 39 executes the above steps S105, S107, S110, S112, S202, and S212. The second fork operation controller 40 executes above steps S105, S107, S109, S111, S203 to S205, and S213 to S215.

In the cargo handling control device 1 described above, in picking up the pallet 5, the forklift truck 2 moves forward so that the fork 6 is inserted into the pallet hole 10 of the pallet 5 from the insertion start position (mentioned above).

Here, when the hole upper sensor 26 detects that the tip portion 6a of the fork 6 is positioned in proximity to the upper wall 11 of the pallet 5 before the fork 6 is inserted into the pallet hole 10 of the pallet 5 placed on a flat ground surface that is not inclined as illustrated in FIG. 7A, the fork 6 moves down toward the center of the pallet 5 in the height direction, as illustrated in FIG. 7B. In that state, the fork 6 is inserted into the pallet hole 10 of the pallet 5, as illustrated in FIG. 7C. As a result, the tip portion 6a of the fork 6 may be prevented from hitting the upper wall 11 of the pallet 5.

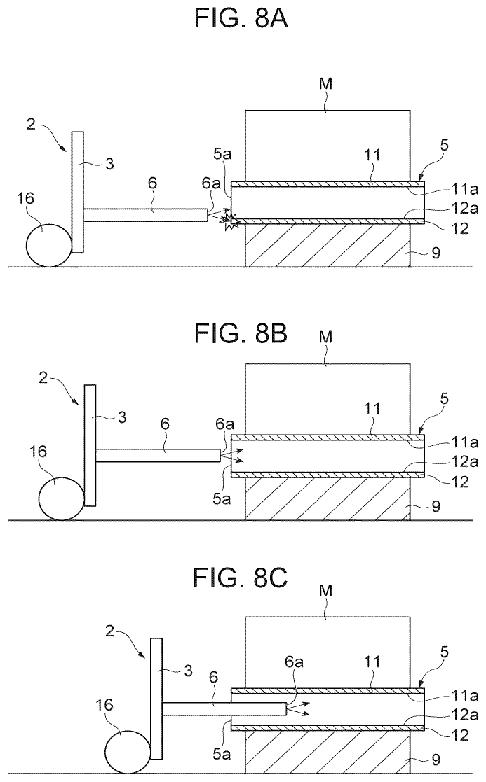

In addition, when the hole lower sensor 27 detects that the tip portion 6a of the fork 6 is positioned in proximity to the lower wall 12 of the pallet 5 before the fork 6 is inserted into the pallet hole 10 of the pallet 5 placed on a flat loading platform 9 that is not inclined as illustrated in FIG. 8A, the fork 6 moves up towards the center of the pallet 5 in the height direction, as illustrated in FIG. 8B. In that state, the fork 6 is inserted into the pallet hole 10 of the pallet 5, as illustrated in FIG. 8C. As a result, the tip portion 6a of the fork 6 may be prevented from hitting the lower wall 12 of the pallet 5.

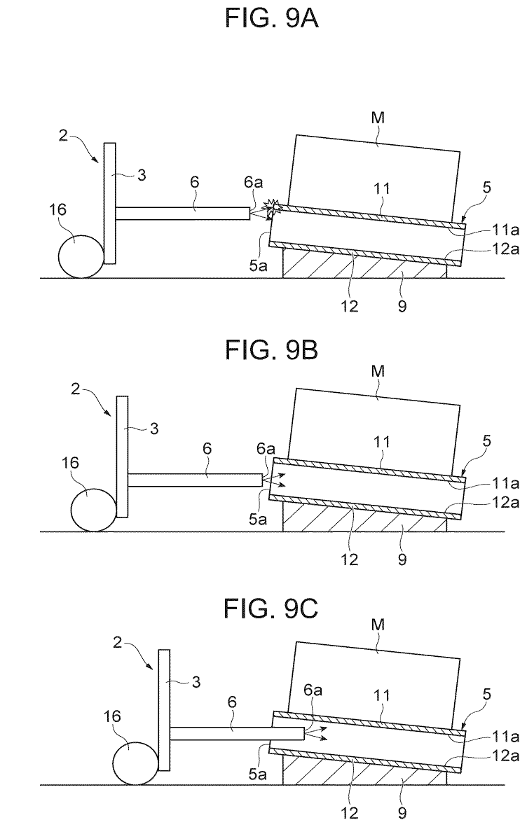

When the hole upper sensor 26 detects that the tip portion 6a of the fork 6 is positioned in proximity to the upper wall 11 of the pallet 5 before the fork 6 is inserted into the pallet hole 10 of the pallet 5 placed on a loading platform 9 that is inclined such that the front side is higher than the rear side, as illustrated in FIG. 9A, the fork 6 move down toward the center of the pallet 5 in the height direction, as illustrated in FIG. 9B. In that state, the fork 6 is inserted into the pallet hole 10 of the pallet 5, as illustrated in FIG. 9C. As a result, the tip portion 6a of the fork 6 may be prevented from hitting the upper wall 11 of the pallet 5.

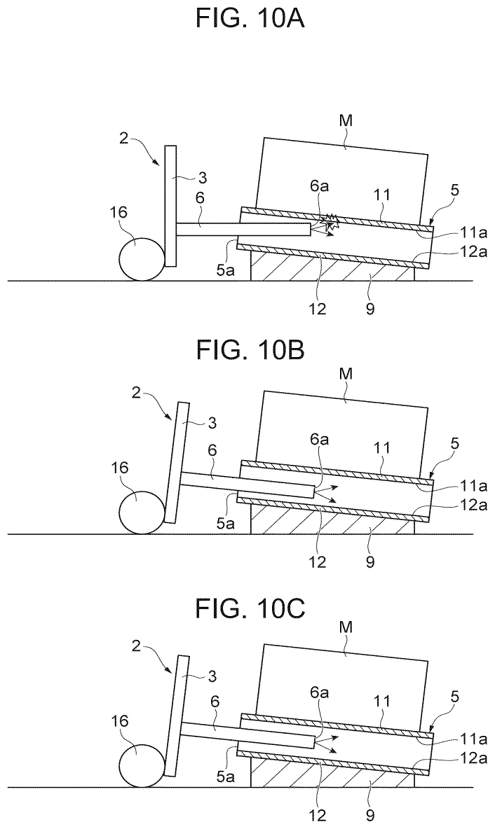

When the hole upper sensor 26 detects that the tip portion 6a of the fork 6 is positioned in proximity to the upper wall 11 of the pallet 5 after the tip portion 6a of the fork 6 is inserted into the pallet hole 10 of the pallet 5, as illustrated in FIG. 10A, the fork 6 tilts forward so that the fork 6 is positioned generally parallel to the inner wall surface 11a of the upper wall 11 of the pallet 5, as illustrated in FIG. 10B. In addition, as illustrated in FIG. 10C, the fork 6 moves upward.

After that, the forklift truck 2 travels while moving the fork 6 down incrementally until the insertion of the fork 6 is complete. Thus, the tip portion 6a of the fork 6 may be prevented from hitting the upper wall 11 of the pallet 5 while the fork 6 tilts forward.

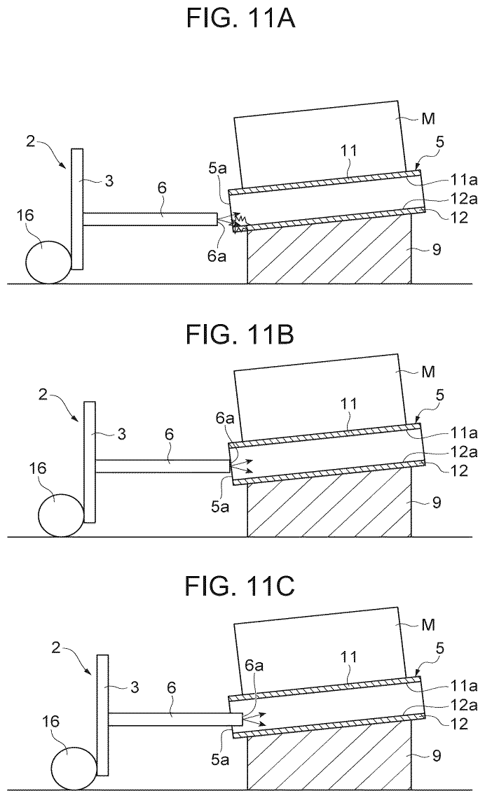

When the hole lower sensor 27 detects that the tip portion 6a of the fork 6 is positioned in proximity to the lower wall 12 of the pallet 5 before the fork 6 is inserted into the pallet hole 10 of the pallet 5 placed on a loading platform 9 that is inclined such that the rear side is higher than the front side, as illustrated in FIG. 11A, the fork 6 moves up toward the center of the pallet 5 in the height direction, as illustrated in FIG. 11B. In that state, the fork 6 is inserted into the pallet hole 10 of the pallet 5, as illustrated in FIG. 11C. As a result, the tip portion 6a of the fork 6 may be prevented from hitting the lower wall 12 of the pallet 5.

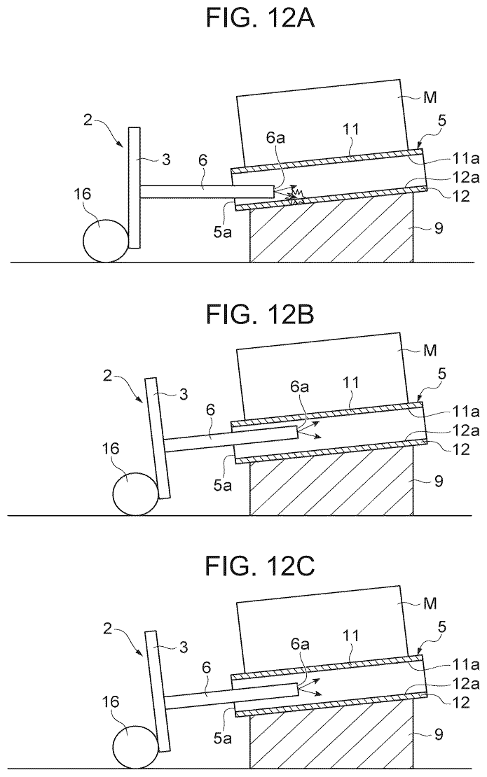

When the hole lower sensor 27 detects that the tip portion 6a of the fork 6 is in proximity to the lower wall 12 of the pallet 5 after the tip portion 6a of the fork 6 is inserted into the pallet hole 10 of the pallet 5, as illustrated in FIG. 12A, the fork 6 tilts backward so that the fork 6 is positioned generally parallel to the inner wall surface 12a of the lower wall 12 of the pallet 5, as illustrated in FIG. 12B. In addition, as illustrated in FIG. 12C, the fork 6 moves down.

After that, the forklift truck 2 travels while moving the fork 6 up incrementally until the insertion of the fork 6 is complete. Therefore, the tip 6a of the fork 6 may be prevented from hitting the lower wall 12 of the pallet 5 while the fork 6 tilts backward.

In the present embodiment, after the approach distance S, which is the distance from the tip portion 6a of the fork 6 to the front surface 5a of the pallet 5, is detected, processing to control the forklift truck 2 so that the fork 6 is inserted into the pallet hole 10 of the pallet 5 is started. Then, based on the approach distance S and the moving distance of the fork 6, the insertion amount P of the fork 6 relative to the pallet hole 10 is calculated. Subsequently, whether the tip portion 6a of the fork 6 is in the pre-insertion state in which the tip portion 6a of the fork 6 has yet to be inserted into the pallet hole 10 is determined based on the insertion amount P of the fork 6 into the pallet hole 10. In the case where it is determined that the tip portion 6a of the fork 6 is in the pre-insertion state in which the tip portion 6a of the fork 6 has yet to be inserted into the pallet hole 10, the lift cylinder 7 is controlled so that the fork 6 moves up and down toward the center of the pallet 5 in the height direction. When it is determined that the tip portion 6a of the fork 6 is in the post-insertion state in which the tip portion 6a of the fork 6 has been inserted into the pallet hole 10, the tilt cylinder 8 is controlled so that the fork 6 tilts to be positioned along the inner wall surface 11a of the upper wall 11 or the inner wall surface 12a of the lower wall 12 of the pallet 5 and the lift cylinder 7 is controlled so that the fork 6 moves up and down toward the center of the pallet 5 in the height direction. In this way, when the tip portion 6a of the fork 6 is in the pre-insertion state in which the tip portion 6a of the fork 6 has yet to be inserted into the pallet hole 10 of the pallet 5, the fork 6 moves up and down the center of the pallet 5 in the height direction. Accordingly, the height of the fork 6 is adjusted to the center of the pallet 5 in the height direction before the tip portion 6a of the fork 6 is inserted into the pallet hole 10 of the pallet 5 even when the fork 6 is not aligned to the center of the pallet 5 in the height direction due to an error in detection of the pallet 5 and an error in control of the fork 6. Thus, the fork 6 is adequately inserted into the pallet hole 10 of the pallet 5, regardless of tilting of the pallet 5. As a result, it is possible to suppress the false detection of the tilting of the pallet 5 and prevent the failure in picking up the pallet 5.

In the present embodiment, in the case where the tip portion 6a of the fork 6 is in the pre-insertion state in which the tip portion 6a of the fork 6 has yet to be inserted into the pallet hole 10 of the pallet 5, when it is detected that the distance from the tip portion 6a of the fork 6 to the upper wall 11 of the pallet 5 is equal to or less than the predetermined value, the fork 6 moves down. In the case where the tip portion 6a of the fork 6 is in the pre-insertion state in which the tip portion 6a of the fork 6 has yet to be inserted into the pallet hole 10 of the pallet 5, when it is detected that the distance from the tip portion 6a of the fork 6 to the lower wall 12 of the pallet 5 is equal to or less than the predetermined value, the fork 6 moves up. Thus, the height of the fork 6 is adjusted to the center of the pallet 5 in the height direction even if the fork 6 is displaced either up or down from the center of the pallet 5 in the height direction. As a result, the fork 6 is more adequately inserted into the pallet hole 10 of the pallet 5, regardless of tilting of the pallet 5.

In the present embodiment, in the case where the tip portion 6a of the fork 6 is in the pre-insertion state in which the tip portion 6a of the fork 6 has yet to be inserted into the pallet hole 10 of the pallet 5, when it is detected that the distance from the tip portion 6a of the fork 6 to the upper wall 11 of the pallet 5 is equal to or less than the predetermined value, the fork 6 moves down incrementally by the certain amount. In the case where the tip portion 6a of the fork 6 is in the pre-insertion state in which the tip portion 6a of the fork 6 has yet to be inserted into the pallet hole 10 of the pallet 5, when it is detected that the distance from the tip portion 6a of the fork 6 to the lower wall 12 of the pallet 5 is equal to or less than the predetermined value, the fork 6 moves up incrementally by the certain amount. Thus, the height of the fork 6 is adjusted incrementally toward the center of the pallet 5 in the height direction even if the fork 6 is displaced either up or down from the center of the pallet 5 in the height direction. Thus, the fork 6 is smoothly inserted into the pallet hole 10 of the pallet 5, regardless of tilting of the pallet 5.

According to the present embodiment, the moving amount of the fork 6 can be easily obtained as the travel distance R of the forklift truck 2. In addition, by using the distance from the tip portion 6a of the fork 6 to the front surface 5a of the pallet 5 (approach distance S) and the travel distance R of the forklift truck 2, the insertion amount P of the fork 6 into the pallet hole 10 of the pallet 5 can be calculated with a simple formula, thereby simplifying the processing.

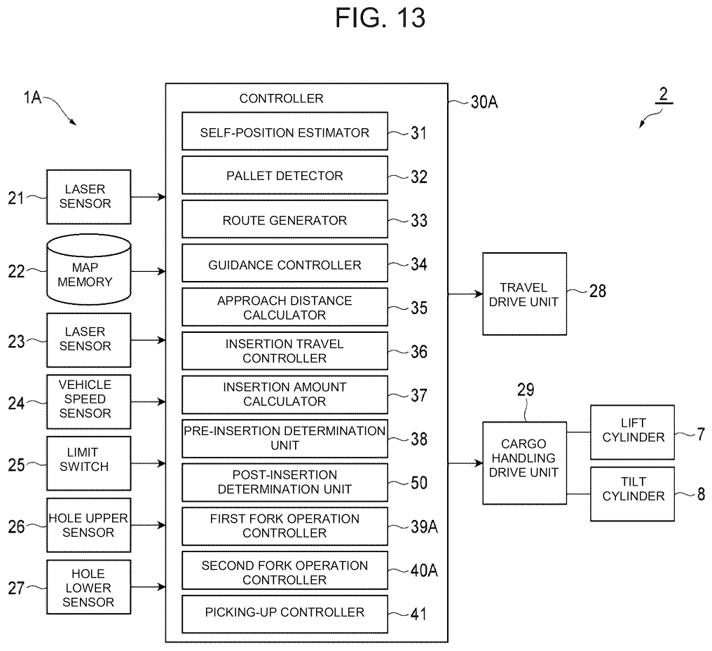

FIG. 13 is a block diagram illustrating a configuration of a cargo handling control device of a forklift truck according to another embodiment of the present disclosure. As illustrated in FIG. 13, a cargo handling control device 1A of the present embodiment includes a controller 30A in place of the controller 30 of the above-described embodiment.

The controller 30A has the self-position estimator 31, the pallet detector 32, the route generator 33, the guidance controller 34, the approach distance calculator 35, the insertion travel controller 36, the insertion amount calculator 37, the pre-insertion determination unit 38, a post-insertion determination unit 50, a first fork operation controller 39A, a second fork operation controller 40A, and the picking-up controller 41.

The post-insertion determination unit 50 determines whether the fork 6 is in a state in which the fork 6 is inserted into the pallet hole 10 of the pallet 5 by a predetermined amount or greater when the pre-insertion determination unit 38 determines that the tip portion 6a of the fork 6 is not in the pre-insertion state in which the tip portion 6a of the fork 6 has yet to be inserted into the pallet hole 10 of the pallet 5.

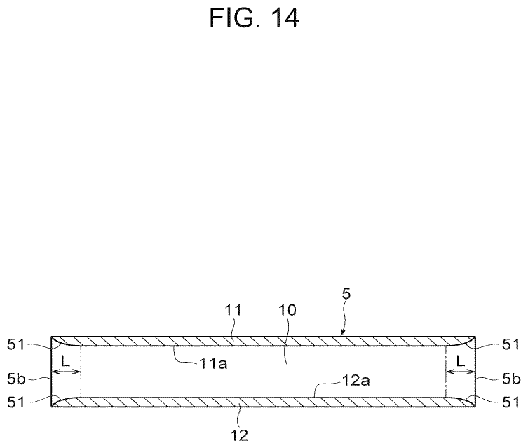

For example, as illustrated in FIG. 14, when chamfered portions 51 are provided on the inner wall surface 11a of the upper wall 11 and the inner wall surface 12a of the lower wall 12 at opening ends of the pallet 5, the predetermined amount is a length L of each of the chamfered portions 51. The chamfered portions 51 each has a curved shape or a tapered shape so that the pallet hole 10 is tapered to an inside of the pallet 5 from opening end surfaces 5b of the pallet 5.

When the post-insertion determination unit 50 determines that the fork 6 is not in the state in which the fork 6 is inserted into the pallet hole 10 of the pallet 5 by the predetermined amount or greater, the first fork operation controller 39A controls the lift cylinder 7 via the cargo handling drive unit 29 so that the fork 6 moves up and down toward the center of the pallet 5 in the height direction.

When the post-insertion determination unit 50 determines that the fork 6 is in the state in which the fork 6 is inserted into the pallet hole 10 of the pallet 5 by the predetermined amount or greater, the second fork operation controller 40A controls the tilt cylinder 8 via the cargo handling drive unit 29 so that the fork 6 tilts to be positioned along the inner wall surface 11a of the upper wall 11 or the inner wall surface 12a of the lower wall 12 of the pallet 5, and controls the lift cylinder 7 via the cargo handling drive unit 29 so that the fork 6 moves up and down toward the center of the pallet 5 in the height direction.

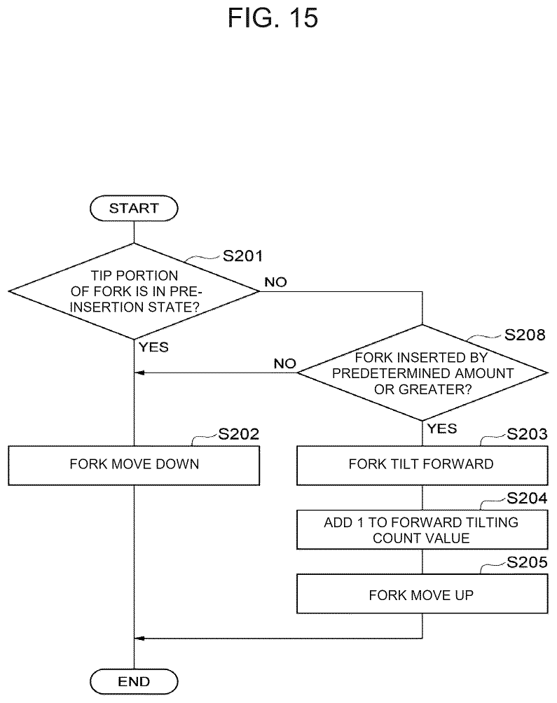

FIG. 15 is a flowchart showing a modified example of the steps of the upper approach fork operation control processing shown in FIG. 5. In FIG. 15, in the case where it is determined in step S201 that the tip portion 6a of the fork 6 is not in the pre-insertion state in which the tip portion 6a of the fork 6 has yet to be inserted into the pallet hole 10 of the pallet 5, based on the insertion amount P of the fork 6 calculated in step S103 in FIG. 4, the controller 30A determines whether the fork 6 is inserted into the pallet hole 10 of the pallet 5 by the predetermined amount or greater (step S208).

When the controller 30A determines that fork 6 is not inserted into pallet hole 10 by the predetermined amount or greater, the controller 30A executes step S202. When the controller 30A determines that fork 6 is inserted into pallet hole 10 by the predetermined amount or greater, the controller 30A executes step S203.

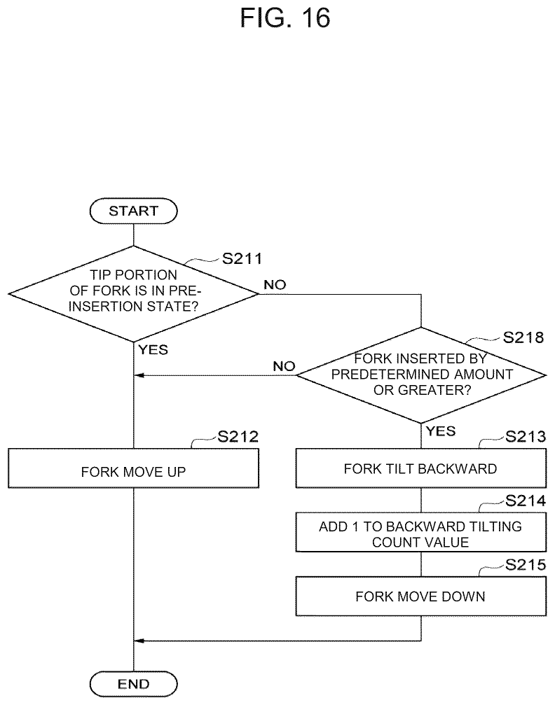

FIG. 16 is a flowchart showing a modified example of the steps of the lower approach fork operation control processing shown in FIG. 6. In FIG. 16, in the case where it is determined in step S211 that the tip portion 6a of the fork 6 is not in the pre-insertion state in which the tip portion 6a of the fork 6 has yet to be inserted into the pallet hole 10 of the pallet 5, based on the insertion amount P of the fork 6 calculated in step S103 in FIG. 4, the controller 30A determines whether the fork 6 is inserted into the pallet hole 10 of the pallet 5 by the predetermined amount or greater (step S218).

When the controller 30A determines that fork 6 is not inserted into pallet hole 10 by the predetermined amount or greater, the controller 30A executes step S212. When the controller 30A determines that fork 6 is inserted into pallet hole 10 by the predetermined amount or greater, the controller 30A executes step S213.

According to the present embodiment described above, when the chamfered portions 51 are provided on the inner wall surface 11a of the upper wall 11 and the inner wall surface 12a of the lower wall 12 at the opening ends of the pallet 5, only moving up and down control of the fork 6 is executed and tilting control of the fork 6 is not executed until the fork 6 is inserted beyond the chamfered portions 51 even when the tip portion 6a of the fork 6 is in the post-insertion state in which the tips 6a of the fork 6 has been inserted into the pallet hole 10 of the pallet 5. As a result, the fork 6 is less likely to hit the upper wall 11 or the lower wall 12 of the pallet 5. Thus, the fork 6 is further adequately inserted into the pallet hole 10 of the pallet 5, regardless of tilting of the pallet 5.

The present disclosure is not limited to the above-described embodiments. For example, according to the above embodiments, when the hole upper sensor 26 detects that the distance from the tip portion 6a of the fork 6 to the upper wall 11 of the pallet 5 is equal to or less than the predetermined value, the fork 6 is moved down incrementally by the predetermined amount to the center of the pallet 5 in the height direction, but the present disclosure is not limited to such a configuration. For example, when the hole upper sensor 26 detects that the distance from the tip portion 6a of the fork 6 to the upper wall 11 of the pallet 5 is equal to or less than the predetermined value, the fork 6 may be moved down until the hole lower sensor 27 detects that the distance from the tip portion 6a of the fork 6 to the lower wall 12 of the pallet 5 is equal to or less than the predetermined value, and then moved up to the center of the pallet 5 in the height direction.

For example, according to the above embodiments, when the hole lower sensor 27 detects that the distance from the tip portion 6a of the fork 6 to the lower wall 12 of the pallet 5 is equal to or less than the predetermined value, the fork 6 is moved up incrementally by the predetermined amount to the center of the pallet 5 in the height direction, but the present disclosure is not limited to such a configuration. For example, when the hole lower sensor 27 detects that the distance from the tip portion 6a of the fork 6 to the lower wall 12 of the pallet 5 is equal to or less than the predetermined value, the fork 6 may be moved up until the hole upper sensor 26 detects that the distance from the tip portion 6a of the fork 6 to the upper wall 11 of the pallet 5 is equal to or less than the predetermined value, and then moved down to the center of the pallet 5 in the height direction.

For example, in the above embodiments, when the hole upper sensor 26 detects that the distance from the tip portion 6a of the fork 6 to the upper wall 11 of the pallet 5 is equal to or less than the predetermined value, the fork 6 is tilted forward incrementally by the certain amount so that the fork 6 is positioned parallel to the pallet 5, but the present disclosure is not limited to such a configuration. For example, when the hole upper sensor 26 detects that the distance from the tip portion 6a of the fork 6 to the upper wall 11 of the pallet 5 is equal to or less than the predetermined value, the fork 6 may be tilted forward until the hole lower sensor 27 detects that the distance from the tip portion 6a of the fork 6 to the lower wall 12 of the pallet 5 is equal to or less than the predetermined value, and then tilted backward to be parallel to the pallet 5.

For example, in the above embodiments, when the hole lower sensor 27 detects that the distance from the tip portion 6a of the fork 6 to the lower wall 12 of the pallet 5 is equal to or less than the predetermined value, the fork 6 is tilted backward incrementally by the certain amount so that the fork 6 is positioned parallel to the pallet 5, but the present disclosure is not limited to such a configuration. For example, when the hole lower sensor 27 detects that the distance from the tip portion 6a of the fork 6 to the lower wall 12 of the pallet 5 is equal to or less than the predetermined value, the fork 6 may be tilted backward until the hole upper sensor 26 detects that the distance from the tip portion 6a of the fork 6 to the upper wall 11 of the pallet 5 is equal to or less than the predetermined value, and then tilted forward to be parallel to the pallet 5.

According to the above embodiment, the approach distance S, which is the distance from the tip portion 6a of the fork 6 to the front surface 5a of the pallet 5, is detected using the laser sensor 23. However, the sensor used for detecting the approach distance S is not limited to the laser sensor 23, but may be a Time-of-Flight camera, or the laser sensor 21 used for self-position estimation mentioned above.

According to the above-described embodiments, the travel distance R of the forklift truck 2 is calculated by multiplying the travel speed of the forklift truck 2 detected by the vehicle speed sensor 24 by the travel time. However, the present disclosure is not limited to such a configuration, and a sensor, such as an odometry sensor, may detect the travel distance R of the forklift truck 2.

According to the above embodiments, the fork 6 is inserted into the pallet hole 10 of the pallet 5 by the forklift truck 2 traveling forward, but the present disclosure is not limited to such a configuration. For example, when the forklift truck 2 is a reach type forklift truck, the fork 6 may be inserted into the pallet hole 10 of the pallet 5 by extending the mast 3 with a reach cylinder.

What is claimed is:

1. A cargo handling control device of a forklift truck including a lift cylinder that moves a fork holding a pallet up and down, and a tilt cylinder that tilts the fork, the cargo handling control device comprising:
an approach distance detector configured to detect an approach distance from a tip portion of the fork to a front surface of the pallet;
an insertion controller configured to control the forklift truck so that the fork is inserted into a pallet hole of the pallet;
an insertion amount calculator configured to calculate an insertion amount of the fork relative to the pallet hole, after the insertion controller starts processing, based on the approach distance detected by the approach distance detector, and a moving distance of the fork;
a pre-insertion determination unit configured to determine whether the tip portion of the fork is in a pre-insertion state in which the tip portion of the fork has yet to be inserted into the pallet hole, after the insertion controller starts processing, based on the insertion amount of the fork relative to the pallet hole calculated by the insertion amount calculator;
a first fork operation controller configured to control the lift cylinder so that the fork moves up and down toward a center of the pallet in a height direction of the pallet, after the insertion controller starts processing, in a case where the pre-insertion determination unit determines that the tip portion of the fork is in the pre-insertion state; and
a second fork operation controller configured to control the tilt cylinder so that the fork tilts to be positioned along an inner wall surface of an upper wall of the pallet or an inner wall surface of a lower wall of the pallet and to control the lift cylinder so that the fork moves up and down toward the center of the pallet in the height direction, after the insertion controller starts processing, in a case where the pre-insertion determination unit determines that the tip portion of the fork is in a post-insertion state in which the tip portion of the fork has been inserted into the pallet hole of the pallet.

2. The cargo handling control device according to claim 1, further comprising:
a pallet upper wall detector configured to detect whether a distance from the tip portion of the fork to the upper wall of the pallet is equal to or less than a predetermined value; and
a pallet lower wall detector configured to detect whether a distance from the tip portion of the fork to the lower wall of the pallet is equal to or less than the predetermined value, wherein
in the case where the pre-insertion determination unit determines that the tip portion of the fork is in the pre-insertion state,
the first fork operation controller controls the lift cylinder so that the fork moves down when the pallet upper wall detector detects that the distance from the tip portion of the fork to the upper wall is equal to or less than the predetermined value, and
the first fork operation controller controls the lift cylinder so that the fork moves up when the pallet lower wall detector detects that the distance from the tip portion of the fork to the lower wall of the pallet is equal to or less than the predetermined value, and
in the case where the pre-insertion determination unit determines that the tip portion of the fork is in the post-insertion state,
the second fork operation controller controls the tilt cylinder so that the fork tilts forward and controls the lift cylinder so that the fork moves up when the pallet upper wall detector detects that the distance from the tip portion of the fork to the upper wall is equal to or less than the predetermined value, and
the second fork operation controller controls the tilt cylinder so that the fork tilts backward and controls the lift cylinder so that the fork moves down when the pallet lower wall detector detects that the distance from the tip portion of the fork to the lower wall of the pallet is equal to or less than the predetermined value.

3. The cargo handling control device according to claim 2, wherein
in the case where the pre-insertion determination unit determines that the tip portion of the fork is in the pre-insertion state,
the first fork operation controller controls the lift cylinder so that the fork moves down incrementally by a certain amount until the pallet upper wall detector detects that the distance from the tip portion of the fork to the upper wall of the pallet is not equal to or less than the predetermined value, when the pallet upper wall detector detects that the distance from the tip portion of the fork to the upper wall is equal to or less than the predetermined value, and
the first fork operation controller controls the lift cylinder so that the fork moves up incrementally by a certain amount until the pallet lower wall detector detects that the distance from the tip portion of the fork to the lower wall of the pallet is not equal to or less than the predetermined value, when the pallet lower wall detector detects that the distance from the tip portion of the fork to the lower wall of the pallet is equal to or less than the predetermined value, and
in the case where the pre-insertion determination unit determines that the tip portion of the fork is in the post-insertion state,
the second fork operation controller controls the tilt cylinder so that the fork tilts forward incrementally by a certain amount and controls the lift cylinder so that the fork moves up incrementally by a certain amount until the pallet upper wall detector detects that the distance from the tip portion of the fork to the upper wall of the pallet is not equal to or less than the predetermined value, when the pallet upper wall detector detects that the distance from the tip portion of the fork to the upper wall is equal to or less than the predetermined value, and
the second fork operation controller controls the tilt cylinder so that the fork tilts backward incrementally by a certain amount and controls the lift cylinder so that the fork moves down incrementally by a certain amount until the pallet lower wall detector detects that the distance from the tip portion of the fork to the lower wall of the pallet is not equal to or less than the predetermined value, when the pallet lower wall detector detects that the distance from the tip portion of the fork to the lower wall of the pallet is equal to or less than the predetermined value.

4. The cargo handling control device according to claim 1, further comprising
a post-insertion determination unit configured to determine whether the fork is in a predetermined amount inserted state in which the fork is inserted into the pallet hole by a predetermined amount or greater when the pre-insertion determination unit determines that the tip portion of the fork is not in the pre-insertion state, wherein
the first fork operation controller controls the lift cylinder so that the fork moves up and down toward the center of the pallet in the height direction when the post-insertion determination unit determines that the fork is not in the predetermined amount inserted state, and
the second fork operation controller controls the tilt cylinder so that the fork tilts to be positioned along the inner wall surface of the upper wall or the inner wall surface of the lower wall, and controls the lift cylinder so that the fork moves up and down toward the center of the pallet in the height direction when the post-insertion determination unit determines that the fork is in the predetermined amount inserted state.

5. The cargo handling control device according to claim 1, wherein
the insertion controller controls the forklift truck so that the forklift truck travels to insert the fork into the pallet hole, and
the insertion amount calculator obtains a travel distance of the forklift truck as the moving distance of the fork, and calculates the insertion amount of the fork relative to the pallet hole based on the approach distance detected by the approach distance detector and the travel distance of the forklift truck.
